(19) United States
(12) Patent Application Publication
(10) Pub. No.: US 2015/0340017 A1
(43) Pub. Date: Nov. 26, 2015

(54) Compensated Saddle for a Stringed Instrument

(71) Applicants: Paul F. Stroh, Seattle, WA (US); Jack M. Jacobson, Walla Walla, WA (US); Jeffrey D. Jacobson, Seattle, WA (US)

(72) Inventors: Paul F. Stroh, Seattle, WA (US); Jack M. Jacobson, Walla Walla, WA (US); Jeffrey D. Jacobson, Seattle, WA (US)

(21) Appl. No.: 14/718,046

(22) Filed: May 20, 2015

Related U.S. Application Data
(60) Provisional application No. 61/997,013, filed on May 20, 2014.

(51) Int. Cl. G10D 3/04

(52) U.S. Cl. CPC G10D 3/04

(57) ABSTRACT

A saddle for a string instrument. The saddle has a main saddle piece and a spindle projecting from the main saddle piece along the same axis. A releasably locking ring is rotatably engaged upon the first spindle, and the ring has a compensation feature.

### CROSS REFERENCE TO RELATED APPLICATIONS

This application claims priority to U.S. Provisional Patent application 61/997013 filed May 20, 2014, which is hereby incorporated by this reference as if fully set forth herein.

### TECHNICAL FIELD

This disclosure relates to musical instruments; more particularly, it relates to tuning musical instruments and in particular a compensated saddle for a stringed instrument.

### BACKGROUND

Existing three-saddle bridges typically make it difficult to accurately tune or intone all six guitar strings. Guitar players have long appreciated the tonal characteristics of the traditional three-saddle bridge which is commonly found on Fender Telecaster-style guitars, among other instruments. Such bridges feature three barrel-shaped saddles that each support two strings and are typically mounted on a steel bridge plate. This classic structure is credited for the distinctive bright tone for which such bridges are known.

Three-saddle bridges however are generally plagued with intonation problems. This is because each saddle supports two strings, one string passing over the top of each end of the barrel-shaped saddle. The two string surfaces on a saddle are fixed relative to each other, making it difficult to intonate each string separately. When a saddle is moved either toward the nut or toward the bridge of a guitar to intonate a string by changing its scale length, it moves for two strings simultaneously. Often it is not possible to accurately intonate both strings sharing a saddle and the effort to do so, which requires checking and rechecking the intonation of both strings after every movement of the saddle length adjustment screw, can be time-consuming and tedious. This lack of precise adjustability leads to the common practice of “splitting the difference,” between the strings, for example, by tuning one string slightly sharp and one slightly flat in an effort to reduce out-of-tune tones from the strings.

In the past, intonation issues with three-saddle bridges were addressed by various efforts to compensate the saddles, that is, to change the scale length of each string by adjusting the location on which each string rests on a saddle relative to the other string. One known compensation method is to alter the tilt of a saddle in relation to the nut and the bridge. Without compensation the three saddles sit roughly parallel to the nut and to the bridge and to each other. By tilting a saddle, for example, one end of the saddle will be closer to the nut than the other end, creating offset surfaces that alter each string's scale length. This tilting concept has been accomplished in various ways: by bending the saddle length adjustment screw, by drilling the hole for the saddle adjustment screw at an angle, and by other methods. Another compensation method is to cut permanent non-adjustable ramps, slots, or grooves on the top of each saddle barrel, where the strings rest, to create a pair of string contact points on the saddle barrel, one that is closer to the nut and one that is closer to the bridge.

A recently disclosed compensation method for such saddles is to attach a moveable sliding piece where the string rests on the top of one end of a saddle. The sliding piece fits into a cutout or channel on the saddle and can slide toward the nut or toward the bridge in an orientation that is roughly parallel to the top of the guitar, but it requires the saddle to be cut flat on at least one end of the bottom of the saddle, to create a surface for the locking nut that permits a roughly parallel sliding capability for intonation adjustment in this method.

All of these previous attempts to compensate such saddles have significant drawbacks, however. First, most do not solve intonation problems for many guitars because the surfaces on a saddle that support two strings remain fixed relative to each other. Therefore the movement of a saddle toward the nut or toward the bridge during intonation continues to affect two strings at once. Second, these efforts at compensation, including the recently disclosed saddle with a sliding component, typically alter the traditional design of the three-saddle bridge in ways that many guitar enthusiasts may find undesirable. For example, they may reduce the mass of a saddle and/or change the basic shape of the saddle, both of which can compromise the tone and appearance of the saddle.

Yet another compensated saddle, now produced out of Japan by the Gotoh company (see U.S. Pat. NO. 8,816,177 to Goto, the specification and drawings of which are hereby incorporated by this reference, as if fully set forth) incorporates a circular, even elliptically shaped circumferential groove around each end of the saddle barrel. One of the two saddle strings rests on an apex in each groove, and the apex of each groove is offset from the other by a fixed angle so that the point at which one of the pair of saddle strings makes contact with the saddle at the apex is nearer or farther from the nut than the other.

This compensation feature also has its drawbacks. As noted above, the surfaces on the saddle that support the two strings remain fixed relative to each other. Again, the movement of the saddle toward the nut or toward the bridge during intonation continues to affect two strings at once.

### DISCLOSURE

An improved compensated saddle for a traditional three-saddle bridge is disclosed. It is may be used to advantage on stringed instruments, in particular six-string electric guitars and also electric basses. The improved saddle retains the traditional tonal and design attributes that are desired by many electric guitar enthusiasts while also permitting precise individual string intonation.

The disclosed compensated saddle is desirable over previous attempts to compensate such saddles because it permits an easy change of relative positions where the strings are supported on the top of each saddle barrel to allow precise intonation of each string while retaining the desired tonal and design characteristics of a traditional three-saddle bridge.

The disclosed saddle allows precise string intonation for each individual string and accurate intonation of all six guitar strings and makes the intonation process easier and faster by allowing a user to set the intonation for the first string on a saddle using the length adjustment screw and then to adjust the second string's intonation independent of the first string, without the need to further move the length adjustment screw. This eliminates the need for any recheck of the intonation for the first string. The disclosed saddle retains the traditional appearance, mass, and tonal characteristics desired by many three-saddle bridge enthusiasts.

One embodiment of the disclosed saddle includes a main saddle piece having an axis, a first spindle projecting from the main saddle piece along substantially the same axis, and a first releasably locking ring rotatably engaged upon the first spindle, the ring including a first compensation feature.

An alternate embodiment of the saddle has a second compensation feature on the main saddle piece.

The saddle can also advantageously have a second spindle projecting from the main saddle piece at an end of the main saddle piece opposite to the first spindle and a second releasably locking ring rotatably engaged upon the second spindle, and the second ring has a second compensation feature.

In any of the disclosed embodiments the compensation feature in the releasably locking ring can be a slot, a ramp, a facet, a depression, an edge or ridge, or a bump or the like feature. Each releasably locking ring can also have a plurality of angularly spaced-apart compensation features. The profile of the releasably locking ring can be a profile other than circular.

### BRIEF DESCRIPTION OF THE DRAWINGS

FIG. 1 is an exploded view of disclosed compensated saddle.

FIG. 2 is a top-down view of assembled saddles mounted on a three-saddle bridge.

FIG. 3 is a horizontal view of assembled saddles mounted on a three-saddle bridge.

FIG. 4 is an exploded view of an alternate version of the disclosed saddle.

FIG. 5 is an exploded view of another alternate version of the disclosed saddle.

### DETAILED DESCRIPTION

The components of the compensated saddle are a saddle that retains traditional characteristics, namely, a classic columnar or barrel-shape, a single length adjustment screw and two height adjustment screws. The saddle also includes a main saddle piece or component having a barrel shape approximating ⅗ of the saddle width (measured saddle end to saddle end) and a spindle.

The spindle has a diameter smaller than the main barrel, and generally the same axis as the main barrel, and the spindle accounts for the remainder of the saddle width (approximately ⅖). There is a hole near the end of the spindle through which a saddle height adjustment screw can pass without restriction. The disclosed saddle also includes a compensation adjustment ring that fits on the spindle, adjacent to the center of the saddle, and which is able to turn, or rotate, freely on the spindle. There is a moveable compensation feature on the outer surface of the compensation adjustment ring that can change the location of where the string rests on the top of the saddle when the ring is rotated.

In some embodiments, the moveable compensation feature is a slot in the adjustment ring, in other embodiments a ramp. In either case, the slot or ramp and a corresponding slot or ramp in the main barrel lie in generally parallel planes generally orthogonal to the axis of the saddle barrel, and these planes are also generally parallel to the strings. The slots are rotatably angularly offset from one another, so they are not parallel to each other.

A ring lock screw passes through the compensation adjustment ring and releasably sets the position of the ring on the saddle relative to the main barrel. There is an outer locking ring that fits on the end of the spindle, adjacent to the compensation adjustment ring. The locking ring is desirably bisected by a hole through which a saddle height adjustment screw can pass.

Turning now to the drawings, the disclosed saddle will be described by reference to the numerals of the drawing figures wherein like numbers indicate like parts.

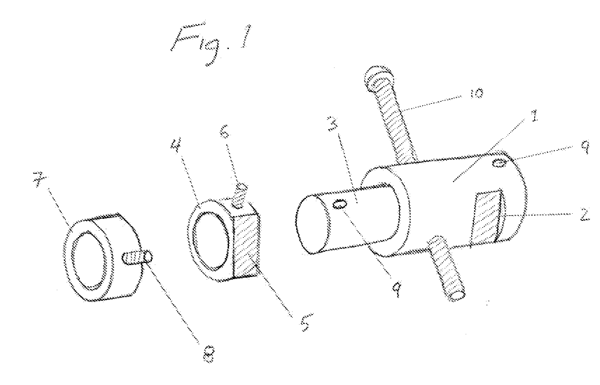

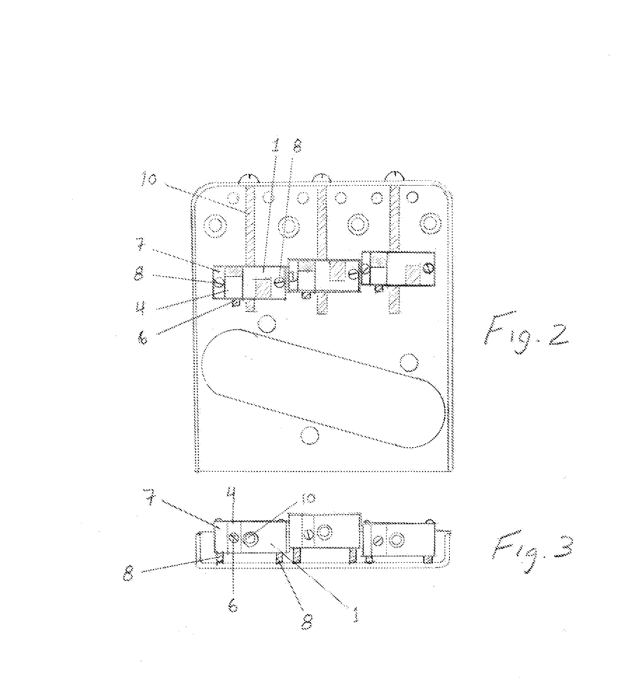

In FIGS. 1, 2 and 3, a main saddle piece 1 includes a non-rotating compensation slot 2, a spindle 3, a saddle length adjustment screw 10, and holes 9 through which saddle height adjustment screws can pass. A compensation adjustment ring (also referred to herein as a releasably locking ring) 4 fits on to the spindle where it can rotate freely adjacent to the main saddle component. A compensation feature 5 on the compensation adjustment ring permits changing the location where the string rests on top of the saddle. A ring lock screw 6, when tightened, sets, or fixes, the location of the compensation ring on the spindle. A fixed ring (also called locking ring) 7 fits on the end of the spindle adjacent to the compensation adjustment ring. A saddle height adjustment screw 8 passes through a hole in the spindle 9 and exits through a hole in the bottom of the fixed ring. Compensation slot 2 is optionally also rotatable such as by providing a second compensation adjustment ring on a second spindle, adjustable in like manner to the above described compensation adjustment ring. (See also further discussion of this optional feature below.)

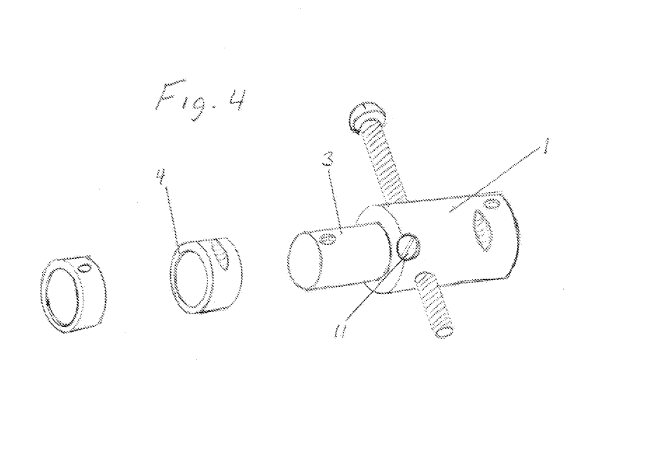

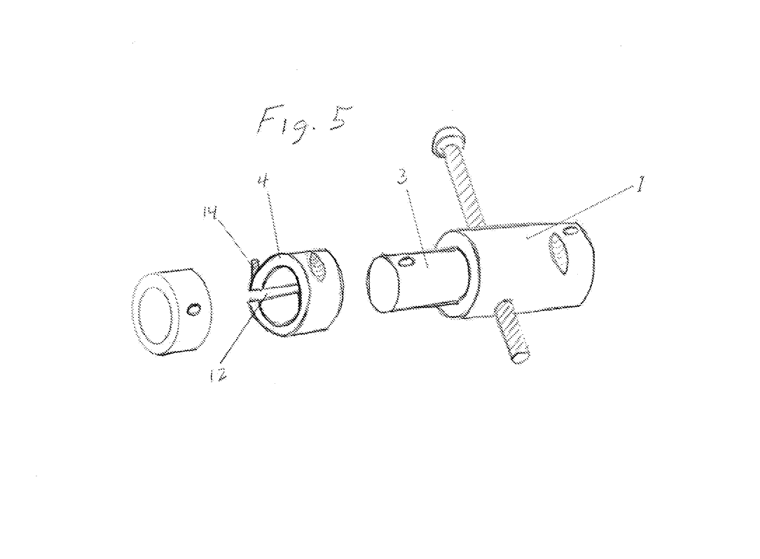

FIGS. 4 and 5 show alternate embodiments of the compensated saddle that demonstrate different ways to set, or fix, the position of the compensation adjustment ring on the spindle. In one embodiment illustrated in FIG. 4, a ring lock screw 11 is threaded into the main saddle component. The head of the fastener overlaps with the rotational course of the compensation adjustment ring such that when the screw is tightened it compresses the ring and prevents it from rotating.

In another embodiment illustrated in FIG. 5, the compensation adjustment ring has a gap 12 on one side. A ring lock screw 14 traverses the gap through a hole drilled in the outer portion of the ring on each side of the gap, compressing the ring and affixing it in place when tightened.

There are also alternative embodiments for the compensated saddle. The rotating compensation adjustment ring may take other forms and be rotatably locked in place on the saddle by other means including, but not limited to, a screw or other fastener that is threaded into or passes through the main saddle component adjacent to the compensation adjustment ring, the ring being fixed in place by the head or flange or washer of the screw or fastener, like the one in FIG. 4; or a screw or fastener that is threaded into the compensation adjustment ring adjacent to the main saddle component, or alternatively, adjacent to the fixed ring, and which overlaps with either component such that when the screw is tightened it prevents rotation of the compensation adjustment ring; or a screw or fastener that is threaded into the fixed ring, the head of the fastener overlapping with the rotational course of the compensation adjustment ring such that when the screw is tightened it compresses the ring and prevents it from rotating; or a screw or fastener that is threaded into or passes through a line that bisects two outer surfaces of the compensation adjustment ring and is tangential to the barrel spindle, the ring having a gap or split on one side to allow it to compress on to the spindle when the screw or fastener is tightened, like the corresponding feature in FIG. 5.

A saddle may omit the locking ring on the end altogether and use instead a single rotating compensation adjustment ring, with a slotted feature on the ring above and below where the height adjustment screw passes through the spindle to permit the ring to turn within a delimited range of motion while providing access and function to the height adjustment screw, as will be appreciated by those skilled in the art.

The compensation adjustment ring may vary significantly in width (that is, relative to the width of the main barrel) in relation to the other saddle components, such as from a narrow profile just large enough to support a string to a much wider form that extends from near the center of the saddle to near the end of the saddle, where a locking ring and saddle height adjustment screw are located.

A compensation adjustment ring may be used on just one side of the saddle as illustrated, or both sides of a saddle (not illustrated).

The compensation adjustment ring may use slots, ramps, facets, depressions, edges, or bumps, of various configurations, on the outer perimeter of the ring to create the moveable feature needed for compensating the saddles.

The compensation adjustment ring may use one, two, three, or more moveable adjustment features on the outer perimeter of the ring to increase the number and variety of moveable features on the ring for compensating the saddle.

The main saddle component may use one or more slots, ramps, facets, depressions, edges, or bumps, of various configurations for supporting a string but does not require the use of any such features.

The compensation adjustment ring may take an outer perimeter shape that is less circular in form than a traditional saddle and displays more pronounced angles, including triangular and rectangular forms, in order to change the way a string rests on the saddle. Compensation adjustment rings may be used on bridges that have different numbers and configurations of saddles. For example, they could be used on a two-saddle bridge (each barrel-shaped saddle holding three compensation adjustment rings).

The compensation adjustment rings may be used on one, two, or three or more saddles on a bridge, as desired or as required for accurate string intonation.

The spindle of the saddle may be integral to the saddle and milled down to its desired form or it can be a separate component that is screwed or bonded to the main body of the saddle, as will be appreciated by those skilled in the art.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

We claim:

1. A saddle for a string instrument comprising:
a main saddle piece having an axis,
a first spindle projecting from the main saddle piece along substantially the same axis, and
a first releasably locking ring rotatably engaged upon the first spindle, the ring comprising a first compensation feature.

2. The saddle of claim 1 wherein the saddle further comprises a second compensation feature on the main saddle piece.

3. The saddle of claim 1 wherein the saddle further comprises a second spindle projecting from the main saddle piece at an end of the main saddle piece opposite to the first spindle and a second releasably locking ring rotatably engaged upon the second spindle, the ring comprising a second compensation feature.

4. The saddle of claim 1 wherein the compensation feature in the releasably locking ring is selected from the group of compensation features consisting of a slot, a ramp, a facet, a depression, an edge or ridge, and a bump.

5. The saddle of claim 4 wherein the compensation feature in the releasably locking ring is a ramp.

6. The saddle of claim 1 further comprising in the releasably locking ring a plurality of angularly spaced-apart compensation features.

7. The saddle of claim 1 wherein the profile of the releasably locking ring is a profile other than circular.
